(19) United States
(12) Patent Application Publication
(10) Pub. No.: US 2026/0270727 A1
(43) Pub. Date: Sep. 10, 2026

(54) METHODS, INFRASTRUCTURE EQUIPMENT, AND COMMUNICATIONS DEVICES

(71) Applicant: Sony Group Corporation, Tokyo (JP)

(72) Inventors: Shin Horng WONG, Basingstoke (GB); Yassin Aden AWAD, Basingstoke (GB)

(73) Assignee: Sony Group Corporation, Tokyo (JP)

(21) Appl. No.: 19/489,281

(22) PCT Filed: Jul. 10, 2024
(86) PCT No.: PCT/EP2024/069559

§ 371 Date: Dec. 2, 2025

(30) Foreign Application Priority Data
Jul. 20, 2023 (EP) 23186757.3

(51) Int. Cl. H04W 24/02; H04L 1/00; H04W 72/12; H04W 72/20; H04W 92/18

(52) U.S. Cl. CPC H04W 24/02; H04L 1/0003; H04W 72/12; H04W 72/20; H04W 92/18

(57) ABSTRACT

A method of operating an infrastructure equipment forming part of a wireless communications network configured to transmit signals to and/or to receive signals from a communications device is provided. The method comprises predicting, based on one or more characteristics of the wireless communications network, one or more properties of a radio channel between the communications device and either the infrastructure equipment or one of one or more other communications devices, determining, based on the predicted properties of the radio channel, one or more transmission parameters to be used for a transmission over the radio channel, and transmitting, to the communications device, a control signal comprising an indication of the one or more transmission parameters to be used for the transmission over the radio channel.

### BACKGROUND

### Field of Disclosure

The present disclosure relates to communications devices, infrastructure equipment and methods for the transmission and/or reception of data by a communications device in a wireless communications network.

The present invention claims the Paris Convention priority from European patent application number EP23186757.3, filed on 20 Jul. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different considerations may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements.

### SUMMARY OF THE DISCLOSURE

The present disclosure can help address or mitigate at least some of the issues discussed above.

Some embodiments of the present technique can provide a method of operating an infrastructure equipment forming part of a wireless communications network configured to transmit signals to and/or to receive signals from a communications device. The method comprises predicting, based on one or more characteristics of the wireless communications network, one or more properties of a radio channel between the communications device and either the infrastructure equipment or one of one or more other communications devices, determining, based on the predicted properties of the radio channel, one or more transmission parameters to be used for a transmission over the radio channel, and transmitting, to the communications device, a control signal comprising an indication of the one or more transmission parameters to be used for the transmission over the radio channel.

Some other embodiments of the present technique can provide a method of operating a communications device configured to transmit signals to and/or to receive signals from a wireless communications network and/or one or more other communications devices. The method comprises determining values of one or more transmission parameters in accordance with which the communications device is to transmit data over a radio channel to the infrastructure equipment or one of the other communications devices, predicting, based on one or more characteristics of the wireless communications network, one or more properties of the radio channel, determining, based on the predicted properties of the radio channel, updated values of the one or more transmission parameters, and transmitting, over the radio channel to the infrastructure equipment or the one of the other communications devices, the data in accordance with the updated values of the one or more transmission parameters.

Such embodiments of the present technique, which, in addition to such methods of operating infrastructure equipment and communications device, relate to other methods of operating communications devices and infrastructure equipment, to communications devices and infrastructure equipment, to circuitry for communications devices and infrastructure equipment, to wireless communications systems, to computer programs, and to computer-readable storage mediums, can allow for the more efficient and effective use of radio resources by a communications device operating in a wireless communications network.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an NR-type wireless telecommunications system which may be configured to operate in accordance with certain embodiments of the present disclosure;

FIG. 2 is a schematic block diagram of an example infrastructure equipment and communications device which may be configured to operate in accordance with certain embodiments of the present disclosure;

FIGS. 3A, 3B, and 3C provide examples of subnetworks in which certain embodiments of the present disclosure may be implemented;

FIG. 4 illustrates an example of Hybrid Automatic Repeat Request (HARQ) transmission for Physical Downlink Shared Channels (PDSCH);

FIG. 5 illustrates an example of HARQ transmissions for Physical Uplink Shared Channels (PUSCH);

FIG. 6 shows an example of legacy PDSCH HARQ transmission for a particular scenario;

FIG. 7 shows an example of fast negative acknowledgement (NACK) HARQ feedback for the scenario shown in FIG. 6;

FIG. 8 shows an example of estimated HARQ feedback for the scenario shown in FIGS. 6 and 7;

FIG. 9 illustrates an example of HARQ transmission in Time Division Duplexing (TDD) systems;

FIG. 10 shows a part schematic, part message flow diagram representation of a first wireless communications system comprising a communications device and an infrastructure equipment in accordance with embodiments of the present technique;

FIG. 11 shows a part schematic, part message flow diagram representation of a second wireless communications system comprising a communications device and an infrastructure equipment in accordance with embodiments of the present technique;

FIG. 12 shows an example of how movement of user equipment (UEs) forming part of a robotic arm may be predicted in accordance with embodiments of the present technique;

FIG. 13 shows an example of pre-emptive retransmission and preventive scheduling techniques based on movement within a subnetwork in accordance with embodiments of the present technique;

FIG. 14 shows how beam direction may be changed based on known or predicted movement in accordance with embodiments of the present technique;

FIG. 15 illustrates how a line of sight (LOS) between an access point (AP) and a UE may be predicted in accordance with embodiments of the present technique;

FIG. 16 illustrates how a UE may perform measurements during movement of that UE within a subnetwork in accordance with embodiments of the present technique;

FIG. 17 shows a flow diagram illustrating a first example process of communications in a communications system in accordance with embodiments of the present technique; and

FIG. 18 shows a flow diagram illustrating a second example process of communications in a communications system in accordance with embodiments of the present technique.

### DETAILED DESCRIPTION OF THE EMBODIMENTS

### New Radio Access Technology (5G)

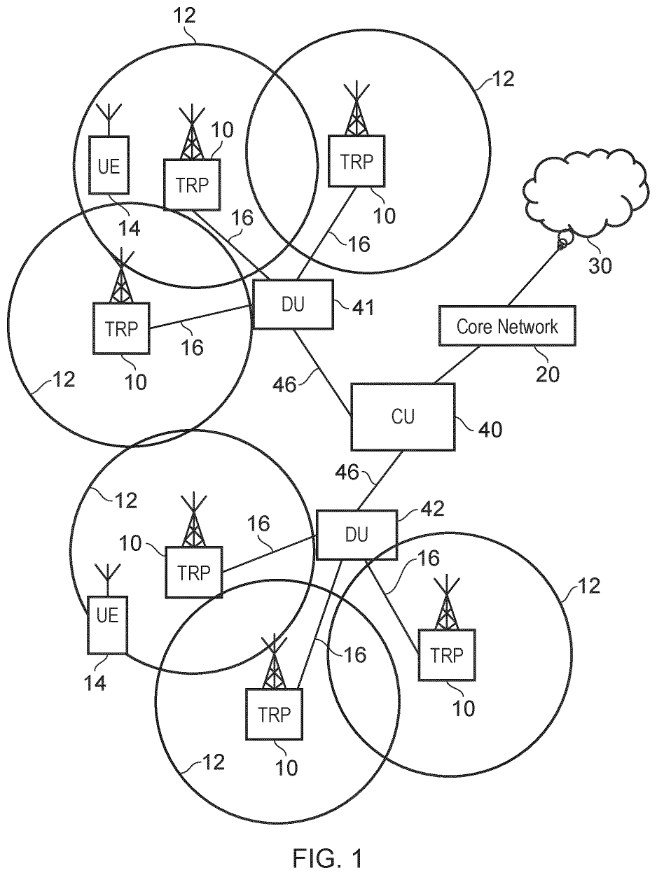

FIG. 1 provides a schematic diagram illustrating an example configuration of a wireless communications network which uses some of the terminology used in NR and 5G but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

In FIG. 1 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a coverage area (i.e. a cell) of the wireless communications network as represented by a circle 12, within which data can be communicated to and from communications devices 14. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30. The core network 20 routes data to and from communications devices 14 via the respective distributed units 41, 42 and provides functions such as authentication, mobility management, charging and so on. The core network 20 may further track the location of the communications devices 14 so that it can efficiently contact (i.e. page) the communications devices 14 for transmitting downlink data towards the communications devices 14.

The elements of the wireless access network shown in FIG. 1 may operate in a similar way to corresponding elements of an LTE network, or future generation mobile communications networks. It will be appreciated that operational aspects of the telecommunications network represented in FIG. 1, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The respective central units 40 and their associated distributed units/TRPs 10 of FIG. 1 may in part have base station functionality. Base stations, which are an example of network infrastructure equipment, may also be referred to as transceiver stations, nodeBs, eNodeBs, eNB, gNodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term (such as gNodeBs or the TRPs of FIG. 1) in relation to certain example implementations is not intended to indicate these implementations are limited to a certain generation of network that may be most associated with that particular terminology. The terms network infrastructure equipment/access node/access point may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. Although each TRP/DU is shown in FIG. 1 as a single entity, the skilled person will appreciate that some of the functions of the TRP/DU/base station may be carried out by disparate, inter-connected elements, such as antennas (or antennae), remote radio heads, amplifiers, etc. Collectively, one or more base stations may form a radio access network.

A communications device 14 is represented in FIG. 1 within the coverage area of the first communication cell 12. This communications device 14 may thus exchange signalling with the first central unit 40 in the first communication cell 12 via one of the distributed units/TRPs 10 associated with the first communication cell 12. Communications devices 14 may also be referred to as mobile stations, user equipment (UE), user terminal, mobile radio, terminal device, and so forth.

It will further be appreciated that FIG. 1 represents merely one example of a proposed architecture for a new RAT based telecommunications system in which approaches in accordance with the principles described herein may be adopted, and the functionality disclosed herein may also be applied in respect of wireless telecommunications systems having different architectures.

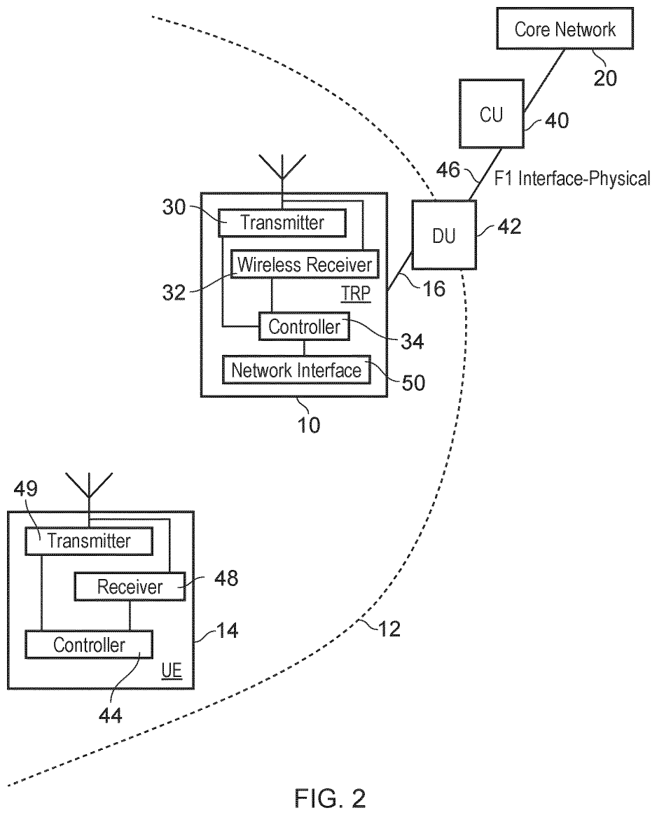

Thus, certain embodiments of the disclosure as discussed herein may be implemented in wireless telecommunication systems/networks according to various different architectures, such as the example architecture shown in FIG. 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a control unit/controlling node 40 and/or a TRP 10 of the kind shown in FIG. 1 which is adapted to provide functionality in accordance with the principles described herein.

A more detailed diagram of some of the components of the network shown in FIG. 1 is provided by FIG. 2. In FIG. 2, a TRP 10 as shown in FIG. 1 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 2, an example UE 14 is shown to include a corresponding transmitter 49, a receiver 48 and a controller 44 which is configured to control the transmitter 49 and the receiver 48 to transmit signals representing uplink (UL) data to the wireless communications network via the wireless access interface formed by the TRP 10 and to receive downlink (DL) data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc. configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 2 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 2, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

URLLC and eURLLC

Systems incorporating NR technology are expected to support different services (or types of services), which may be characterised by different requirements for latency, data rate and/or reliability. For example, Enhanced Mobile Broadband (eMBB) services are characterised by high capacity with a requirement to support up to 20 Gb/s. The requirements for Ultra Reliable and Low Latency Communications (URLLC) services are for one transmission of a 32 byte packet to be transmitted from the radio protocol layer 2/3 SDU ingress point to the radio protocol layer 2/3 SDU egress point of the radio interface within 1 ms with a reliability of 1-10⁻⁵ (99.999%) or higher (99.9999%) [1].

Massive Machine Type Communications (mMTC) is another example of a service which may be supported by NR-based communications networks. In addition, systems may be expected to support further enhancements related to Industrial Internet of Things (IIoT) in order to support services with new requirements of high availability, high reliability, low latency, and in some cases, high-accuracy positioning Enhanced URLLC (eURLLC) [2] specifies features that require high reliability and low latency, such as factory automation, transport industry, electrical power distribution, etc. in a 5G system. eURLLC is further enhanced as IIoT-URLLC [3], for which one of the objectives is to enhance UE feedback for Hybrid Automatic Repeat Request Acknowledgements (HARQ-ACK) for Physical Downlink Shared Channel (PDSCH) transmissions.

### Future 6G Wireless Communications

As described above, several generations of mobile communications have been standardised globally up to now, where each generation took approximately a decade from introduction before the development and introduction of another new generation. For example, generations of mobile communications have moved from the Global System for Mobile Communications (GSM) (2G) to Wideband Code Division Multiple Access (WCDMA) (3G), from WCDMA (3G) to LTE (4G), and most recently from LTE (4G) to NR (5G).

The latest generation of mobile communications is 5G, as discussed above with reference to the example configurations of FIGS. 1 and 2, where a significant number of additional features have been incorporated in different releases to provide new services and capabilities. Such services include eMBB, IIOT and URLLC as discussed above, but also include such services as 2-step Random Access (RACH), Unlicensed NR (NR-U), Cross-link Interference (CLI) handling for Time Division Duplexing (TDD), Positioning, Small Data Transmissions (SDT), Multicast and Broadcast Services (MBS), Reduced Capability UEs, Vehicular Communications (V2X), Integrated Access and Backhaul (IAB), UE power saving, Non Terrestrial Networks (NTN), NR operation up to 71 GHz, IoT over NTN, Non-public networks (NPN), and Radio Access Network (RAN) slicing.

Nevertheless, as in every decade, a new generation (e.g. 6G) is expected to be developed and deployed in the near future (around the year 2030), and will be expected to provide new services and capabilities that the current 5G cannot provide. There are discussions on technologies beyond 5G, i.e. 6G, that are expected to have significantly higher throughput, lower latency and higher reliability than 5G services, which are also expected to utilise sub-THz frequencies. One of the functionalities being considered for 6G is operation within a subnetwork.

### Subnetworks

A subnetwork is a localized network of communication points. Subnetworks have the following characteristics:
Short range (below 10 meters) low transmit power cells;
Extreme requirements in terms of latency, reliability or data rates, i.e. below 0.1 ms latencies, reliability with a packet error rate of 1-10⁻⁹ (99.9999999%) reliability, and multi-Gbps data rates. A subnetwork can be defined as having any one or more of these latency, reliability, or data rate requirements;
Consist of one or multiple access points (AP), e.g. gNBs, with edge processing capabilities; and
May consist of a large number of low complexity or low cost communications devices, such as sensors or actuators.

The extreme reliability and latency of the subnetwork links, which can be downlink, uplink, or sidelink, make such subnetworks links suitable for replacing wires, thereby reducing the amount of wiring required in the system, which in some cases, e.g. in a car or robot, would result in a significant reduction of their weights and size. Reducing the amount of wiring required in a system or unit would also make manufacturing and installation of that system or unit easier.

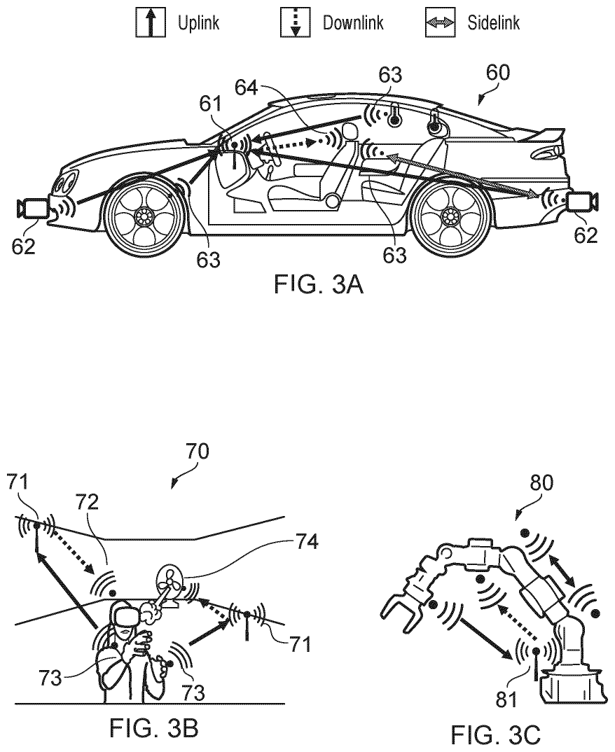

Some examples of subnetworks are shown in FIGS. 3A to 3C. Here, as shown in the example of FIG. 3A, a car 60 can consist of a subnetwork, where cameras 62, sensors 63 (such as light detection and ranging (LIDAR) or tyre pressure sensors), and entertainment devices 64 (such as screens or speakers) that are both outside and inside the car 60 together with an AP 61 can form a subnetwork. The wireless links of the subnetwork would significantly reduce the amount of required wiring, and hence weight, in the car 60.

In other use-cases, a subnetwork can also be in a living room for the purpose of providing immersive VR entertainment. An example of such a home entertainment based subnetwork 70 is shown in FIG. 3B, where a user's headset 72, movement sensors 73 in the user's haptic gloves, and a fan 74 that blows wind at intensity depending on the scenario currently being experienced in the immersive VR entertainment content may together all form a subnetwork which connects to multiple APs 71.

A subnetwork can also be within a single machine, such as a robot arm 80 as shown in the example of FIG. 3C. In the robot arm 80 shown in FIG. 3C, the sensors, joints, and pneumatic systems used to control movements, along with one or more APs 81, may together all form a subnetwork. Like in the car 60 as shown in the example of FIG. 3A, this may significantly reduce the amount of required wiring, which in turn would allow for the robot arm 80 to be made smaller and lighter.

### Channel State Information

In legacy 5G systems, the UE is configured to provide feedback of the radio channel. For example, the UE may be configured to provide such radio channel feedback in the form of a channel quality indicator (CQI) in a channel state information (CSI) report, which indicates the modulation and coding (MCS) that the UE would need for a PDSCH in order to achieve a target block error rate (BLER). The gNB would then take the indicated CQI together with HARQ feedback (ACK/NACK) to perform link adaptation and determine a suitable MCS for a PDSCH to be scheduled to be transmitted to the UE.

Reports such as CQI and HARQ feedback are based on past radio channel information and may not be applicable for a future transmission as such information can quickly become out of date. For example, the CQI reported by a UE may indicate a good radio channel during the past 100 ms, which may lead to the gNB using a high MCS for a future transmission to the UE. However, at the time when the gNB actuals transmits that future transmission to the UE, the radio channel have become degraded, for example, due to the Line of Sight (LOS) being blocked by an object, which causes the transmission to fail. A failed transmission will lead to a retransmission, which introduces latency.

### 5G HARQ Transmissions

In legacy systems such as 5G, a Hybrid Automatic Repeat Request (HARQ) transmission is used for the transmission of physical channels carrying data, such as Physical Downlink Shared Channels (PDSCHs) and Physical Uplink Shared Channels (PUSCHs). Here, such HARQ transmissions consist, after the initial transmission of the physical channels carrying the data, of HARQ feedback from the receiver and, if necessary, retransmissions from the transmitter. For example, an initial transmission of a physical channel may be transmitted to a receiver, and the receiver would feed back an ACK if it successfully decodes the physical channel, or otherwise it feeds back a NACK. A retransmission of the physical channel may be transmitted to the receiver if the HARQ feedback for the previous or initial transmission was a NACK, and here, the receiver would soft-combine the logarithmic likelihood ratio (LLR) soft bits of the retransmitted physical channel with all previous transmissions of the same physical channel. This would thereby increase the signal-to-noise ratio (SNR) of the transmission, and after the soft combining, the receiver then attempts to decode the transmission again. There is typically a configured maximum number of retransmissions of a physical channel before the transmission is abandoned.

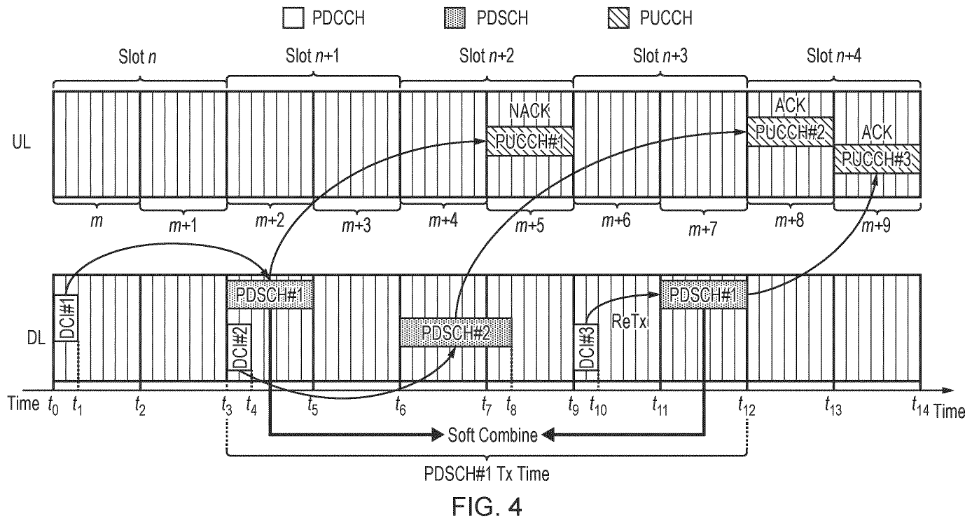

An example of PDSCH HARQ transmissions in the DL is shown in FIG. 4, where a DL Grant carried by downlink control information (DCI #1) is transmitted to a UE in Slot n to schedule a PDSCH #1 in Slot n+1 with a corresponding PUCCH #1 in sub-slot m+5 (Slot n+2) to carry the HARQ feedback for PDSCH #1. In the example of FIG. 4, the UE fails to decode PDSCH #1 and therefore feeds back a NACK in PUCCH #1. The gNB receiving the NACK would send another DL Grant DCI #3 in Slot n+3 scheduling a retransmission of a PDSCH #1 in the later part of Slot n+3 with a corresponding PUCCH #3 in sub-slot m+9 (Slot n+4). The UE soft-combines PDSCH #1 received in Slot n+1 with PDSCH #1 in Slot n+3, thereby increasing the SNR of the physical channel, and here, the UE successfully decodes PDSCH #1 and so feeds back an ACK using PUCCH #3. The total time required for the UE to successfully receive PDSCH #1 is the time between t₃ and t₁₂. The HARQ Round Trip Time (RTT) is the time between the transmission of the PDSCH and its following retransmission. For example, for PDSCH #1, the HARQ RTT is the time between time t₃ and t₁₁, which consists of processing time at both the UE and gNB. A Send and Wait (SAW) mechanism is employed for HARQ transmissions, where during the HARQ RTT of one HARQ process, another HARQ process can occur so that the resources can be fully utilised for data transmissions. In the example of FIG. 4, during the HARQ RTT for PDSCH #1, another HARQ process for PDSCH #2 can occur, where here, DL Grant DCI #2 in Slot n+1 schedules a PDSCH #2 in Slot n+2 with a corresponding PUCCH #2 in sub-slot m+8 (Slot n+4), where PDSCH #2 occurs between the initial PDSCH #1 in Slot n+1 and the PDSCH #1 retransmission in Slot n+3. The gNB and UE keep track of the HARQ process using a HARQ Process Number (HPN), and the UE maintains a soft buffer for each HARQ process for soft combining.

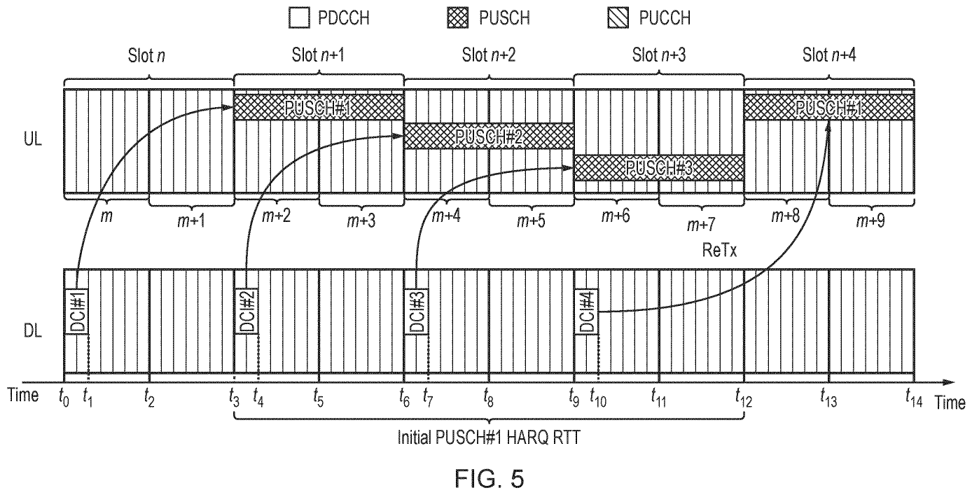

HARQ transmissions in the uplink for PUSCH is similar to those in the downlink for PDSCH as described above, and shown with respect to the example of FIG. 4. An example of PUSCH HARQ transmissions in the UL is illustrated by FIG. 5, which shows three HARQ processes for PUSCH #1, PUSCH #2, and PUSCH #3. The gNB transmits a UL Grant DCI #1 to the UE in Slot n to schedule an initial PUSCH #1 to be transmitted by the UE in Slot n+1. The gNB fails to decode PUSCH #1 and so transmits DCI #4 in Slot n+3 to schedule a retransmission for PUSCH #1 at Slot n+4, where after combining the initial PUSCH #1 transmission and its retransmissions, the gNB successfully decodes PUSCH #1. In 5G systems, unlike for PDSCH transmissions, the gNB does not provide an explicit HARQ feedback such as ACK or NACK for PUSCH. Instead, if the gNB needs a retransmission, it simply sends an UL Grant indicating that the PUSCH of a particular HPN is to be a retransmission (as opposed to a new initial transmission). The UE would store the PUSCH encoded bits in its HARQ buffer for a predetermined amount of time, where if then does not receive any UL Grant for a retransmission by the point this timer expires, the UE flushes its HARQ buffer (for that HPN) and assumes that the gNB has received the PUSCH successfully. In the example in FIG. 5, the gNB employs SAW, and transmits PUSCH #2 and PUSCH #3 back-to-back, to maximise the throughput of the UE during the HARQ RTT of the initial PUSCH #1.

The 6G subnetwork has a target of extremely high reliability and low latency as noted above, and so the legacy 5G HARQ transmission techniques may not meet such a high demand. Although the reliability may individually be reached by having a high number of retransmissions in 5G, each retransmission introduces latency due to the time required for decoding at the gNB or UE. For the PDSCH case, the HARQ feedback from the UE is issued before a retransmission can occur. Hence, there is motivation to improve the legacy HARQ transmission techniques currently employed in 5G for future use cases in 6G subnetworks.

### Fast NACK Feedback

In order to reduce the latency in HARQ retransmissions, fast NACK feedback was considered for PDSCH in co-pending European Patent Application, Publication No. EP4104343 [4], the contents of which are hereby incorporated by reference. Here, the UE is provided with two PUCCH resources, where a first PUCCH is used to carry a NACK and a second PUCCH is used to carry an ACK, and the first PUCCH is scheduled earlier than the second PUCCH in time. Hence, if the UE fails to decode a PDSCH, it would provide a NACK HARQ feedback faster than it would be able to transmit an ACK, to enable the gNB to quickly provide a retransmission of the PDSCH.

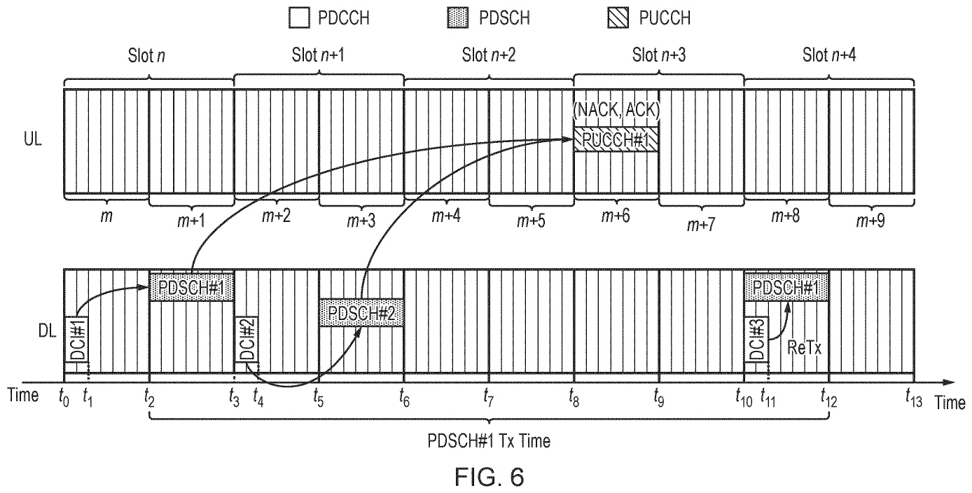

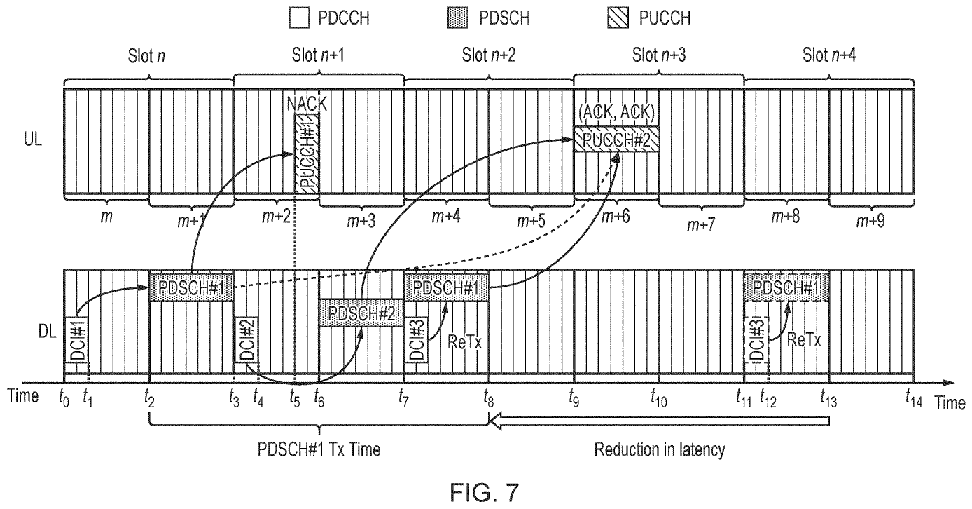

The examples of FIG. 6 and FIG. 7 respectively show how the legacy PDSCH HARQ transmission and fast NACK HARQ feedback may differ for the transmission of PDSCH #1. In the legacy PDSCH HARQ transmission shown in the example of FIG. 6, the gNB sends a DL Grant DCI #1 in Slot n to schedule PDSCH #1 in the same slot and with a corresponding PUCCH #1 to carry its HARQ feedback in Slot n+3. The gNB also sends DL Grant DCI #2 in Slot n+1 to schedule PDSCH #2 in the same slot with the HARQ feedback also in PUCCH #1. In 5G HARQ, feedbacks for multiple PDSCHs are typically multiplexed into a single PUCCH to reduce resources, and here, PUCCH #1 carries the HARQ feedbacks for PDSCH #1 and PDSCH #2. The UE fails to decode PDSCH #1 but successfully decodes PDSCH #2, and so it feeds back a NACK for PDSCH #1 and an ACK for PDSCH #2 in PUCCH #1 in Slot n+3. The gNB then sends another DL Grant DCI #3 in Slot n+4 to schedule a retransmission for PDSCH #1 in the same slot and, in this example, the UE successfully decodes PDSCH #1 after combining the retransmission with the initial transmission of PDSCH #1. The transmission time for PDSCH #1 is therefore t₁₂-12.

FIG. 7 shows the same scenario where the gNB transmits PDSCH #1 and PDSCH #2 to the UE, but here the system employs fast NACK feedback. Here, the UE is provided with two PUCCHs for PDSCH #1, i.e. PUCCH #1 for NACK if PDSCH #1 is not successfully received and decoded in sub-slot m+2 (Slot n+1) and PUCCH #2 in Slot n+3 as per legacy HARQ feedback techniques. PUCCH #2 also multiplexes HARQ feedback for PDSCH #2. When the UE fails to decode the initial PDSCH #1 in Slot n, the UE sends a NACK using PUCCH #1 in Slot n+1 and here the gNB is able to react quickly and send DL Grant DCI #3 in Slot n+2 to schedule a retransmission for PDSCH #1 in the same slot. In this example of FIG. 7, PUCCH #2 is used to carry the HARQ feedback for the retransmission of PDSCH #1. In this example, the UE successfully decodes PDSCH #1 after combining the initial transmission and retransmission of PDSCH #1. It can be appreciated that using fast NACK, the transmission time for PDSCH #1 is reduced from t₁₃−t₁₂ (corresponding to t₁₂−t₂ in the example of FIG. 6) to t₈−t₂, thus providing a reduction in latency of t₁₃−t₈.

### Early Estimated HARQ Feedback

In [5], it is proposed to estimate the decoding outcome of a PDSCH based on LLR soft bits and provide an early HARQ feedback (effectively a prediction) in addition to the legacy HARQ feedback based on the outcome of full decoding. That is, the UE provides two HARQ feedbacks for a PDSCH decoding; an early HARQ feedback based on estimation of the decoding outcome from the LLR soft bits, and the legacy HARQ feedback based on the full decoding process of the PDSCH. The full decoding process of PDSCH takes a longer time than the estimation using LLR soft bits, and this therefore enables the estimated HARQ feedback to be sent to the gNB faster than the legacy HARQ feedback. Hence, where the estimated HARQ feedback proves on full decoding to be correct, the amount of latency in the system can be reduced.

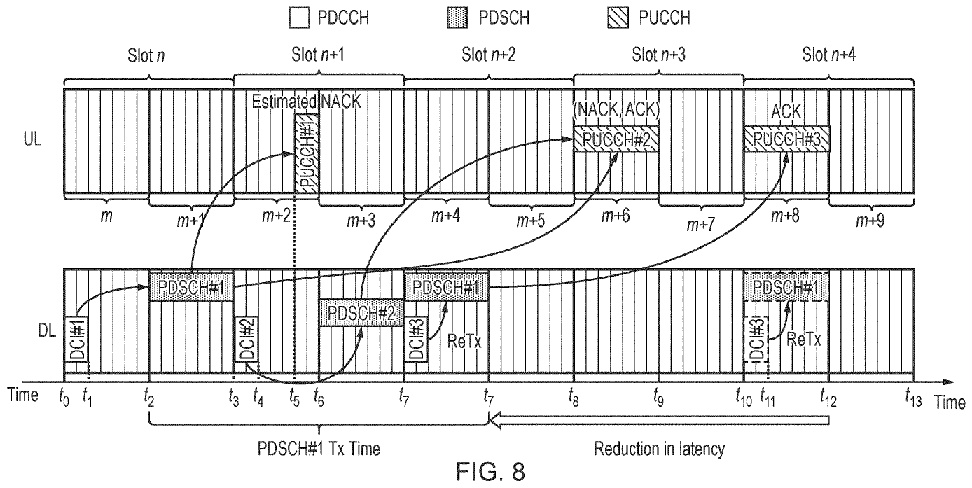

An example is shown in FIG. 8, which relates to the same scenario as those in FIGS. 6 and 7 but here, the example of FIG. 8 employs estimated HARQ feedback on the initial PDSCH #1 transmission in Slot n based on LLR soft bits. Based on the LLR soft bits of the initial PDSCH #1, the UE estimates that it would fail to decode PDSCH #1, and so sends a NACK in PUCCH #1 in Slot n+1, where PUCCH #1 is used to carry the estimated HARQ feedback. The gNB then sends DL Grant DCI #3 in Slot n+2 to schedule a retransmission of PDSCH #1 and with a corresponding PUCCH #3 in Slot n+4 to carry the HARQ feedback. In Slot n+3, the UE multiplexes HARQ feedbacks for PDSCH #1 and PDSCH #2 in PUCCH #2, where for PDSCH #1, it also provides the actual HARQ feedback based on the full decoding process and in this example the NACK for PDSCH #1 in PUCCH #2 confirms that the early NACK estimation is correct. In this example, the UE successfully decodes PDSCH #1 after combining the initial transmission and retransmission of PDSCH #1 and therefore feeds back an ACK in PUCCH #3. It can thus be observed from the example of FIG. 8 that using early estimation of HARQ feedback can reduce the transmission time of PDSCH #1, and thus reduce overall latency.

The fast NACK feedback methods in [4] and [5] both rely on the UE providing an early NACK or early estimated HARQ feedback so that the gNB is able to react quickly and issue a retransmission of the PDSCH where it is (or is expected to be) necessary. That is, the methods described in [4] and [5] and shown by way of the examples of FIGS. 6, 7, and 8 each assume that there are UL resource available for an early NACK, which is a reasonable assumption in an FDD system. However, in a TDD system, uplink resources are not always available at all times and therefore it may not be possible to provide an early estimated HARQ or NACK feedback.

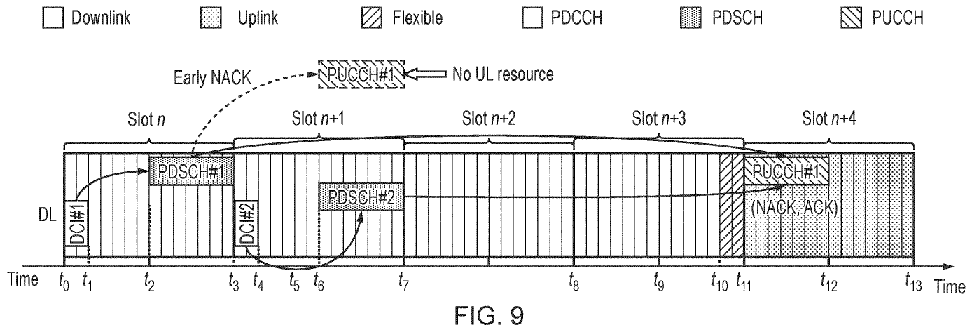

In a typical TDD network, the Slot Format may consist of a periodic pattern of 5 slots consisting of four DL slots followed by one UL slot, with one or two Flexible symbols prior to the UL slot for the purposes of timing advance and DL to UL transition time, as shown in the example of FIG. 9. The scenario in FIG. 9 is similar to the scenarios shown in FIGS. 6, 7, and 8, where the gNB transmits PDSCH #1 and PDSCH #2 to the UE, but in a TDD system. Since there are no UL resources from Slot n to Slot n+3, PUCCH #1 is scheduled in the earliest available UL slot in Slot n+4, where it carries the HARQ feedback for PDSCH #1 and PDSCH #2. The methods described in [4] and [5], and those described with regard to the examples of FIG. 7 and FIG. 8 respectively, cannot be implemented here, since any early HARQ feedback estimation or fast NACK decoding cannot be transmitted in Slot n+1. The earliest time the gNB can receive a NACK for PDSCH #1 is in the UL slot in Slot n+4, and so the gNB cannot perform early retransmission to reduce latency.

It should be noted that for higher frequencies such as FR2 and sub-THz in 6G, the system is likely to be in TDD rather than FDD, and hence fast NACK methods may not be suitable. Therefore, a technical issue to solve here is to find a method that enables accurate scheduling that avoids decoding failure and if failure occurs enables faster retransmissions in 6G systems, especially for 6G subnetworks that require extreme reliability and low latency. Embodiments of the present technique seek to provide solutions to such a technical issue.

### Channel Prediction for Pre-Emptive Retransmissions and Preventive Scheduling

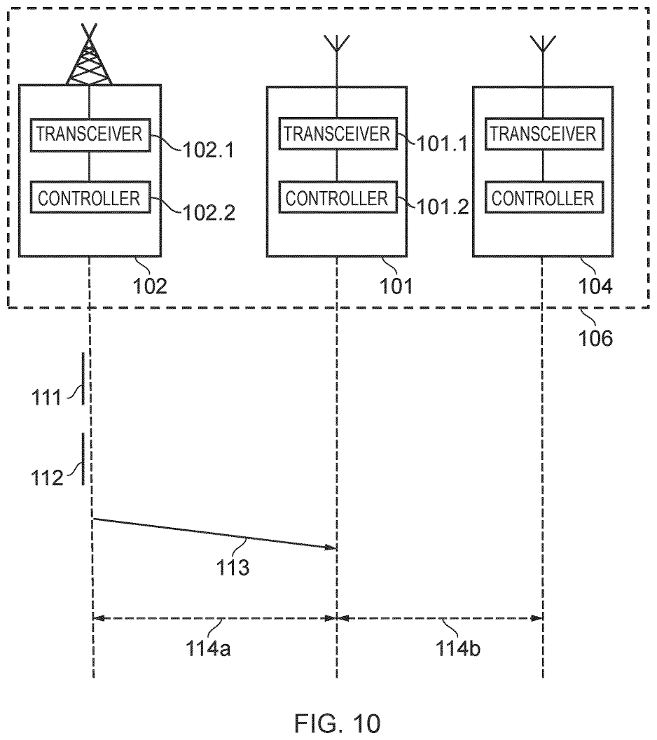

FIG. 10 shows a part schematic, part message flow diagram representation of a first wireless communications system comprising a communications device 101 (e.g., a UE 14) and an infrastructure equipment 102 (e.g., an AP such as a gNB/TRP 10) in accordance with at least some embodiments of the present technique. The communications device 101 is configured to transmit signals to and/or receive signals from the wireless communications network, for example, to and from the infrastructure equipment 102. Specifically, the communications device 101 may be configured to transmit data to and/or receive data from the wireless communications network (e.g., to/from the infrastructure equipment 102) via a wireless radio interface provided by the wireless communications network (e.g., a Uu interface between the communications device 101 and the Radio Access Network (RAN), which includes the infrastructure equipment 102). Here, the communications device 101 and the infrastructure equipment may, together with one or more other communications devices 104 (and optionally with one or more other APs/gNBs which are not shown in the example of FIG. 10), form a subnetwork of the wireless communications network. The communications device 101 and the infrastructure equipment 102 each comprise a transceiver (or transceiver circuitry) 101.1, 102.1, and a controller (or controller circuitry) 101.2, 102.2. Each of the controllers 101.2, 102.2 may be, for example, a microprocessor, a CPU, or a dedicated chipset, etc.

As shown in the example of FIG. 10, the transceiver circuitry 102.1 and the controller circuitry 102.2 of the infrastructure equipment 102 are configured in combination to predict 111, based on one or more characteristics of the wireless communications network, one or more properties of a radio channel between the communications device 101 and either the infrastructure equipment 102 or one of one or more other communications devices 104, to determine 112, based on the predicted properties 111 of the radio channel, one or more transmission parameters to be used for a transmission over the radio channel, and to transmit 113, to the communications device 101, a control signal comprising an indication of the one or more transmission parameters to be used for the transmission over the radio channel. Here, the transceiver circuitry 101.1 and the controller circuitry 101.2 of the communications device 101 may then be configured in combination to perform (i.e., either by transmitting or receiving) the transmission (using the one or more transmission parameters indicated 113 by the infrastructure equipment 102) over the radio channel either with 114a the infrastructure equipment 102 or with 114b the one of the other communications devices 104. Here, the transmission performed by the communications device 101 over the radio channel may comprise the communications device 101 transmitting 114a uplink data to the infrastructure equipment 102, receiving 114a downlink data from the infrastructure equipment, transmitting 114b sidelink data to the one of the other communications devices 104, or receiving 114b sidelink data from the one of the other communications devices 104. The (uplink, downlink, or sidelink) transmission may be an initial transmission of (uplink, downlink, or sidelink) data, using the transmission parameters indicated 113 by the infrastructure equipment, or it may be a retransmission of a previous transmission over the radio channel, and here the control signal may be transmitted 113 by the infrastructure equipment 102 before an acknowledgement feedback signal is transmitted (by any of the communications device 101, other communications device 104, or infrastructure equipment 102 itself) in response to the previous transmission.

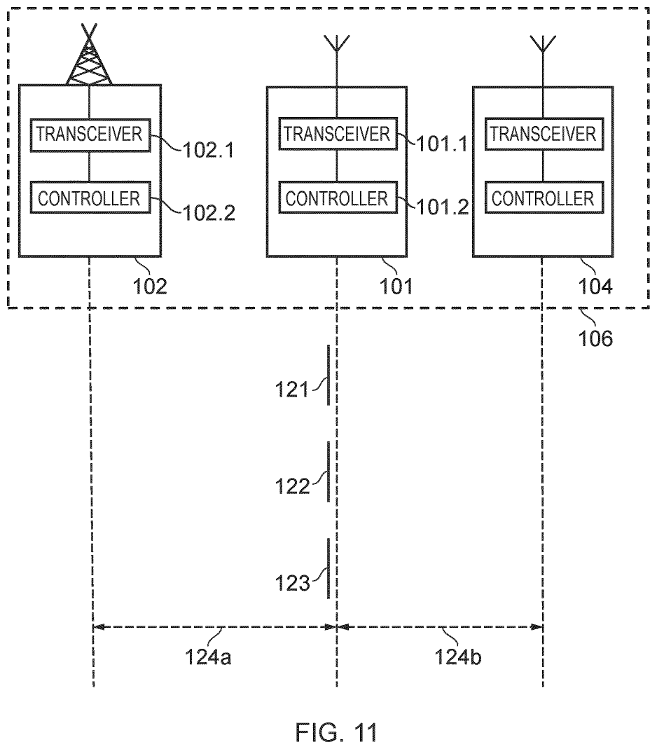

In some other embodiments of the present technique, however, the communications device may control its own predictive scheduling decisions, rather than applying instructions from the infrastructure equipment. FIG. 11 shows a part schematic, part message flow diagram representation of a second wireless communications system, which generally corresponds to the first wireless communications system as shown in FIG. 10, and comprises a communications device 101 (e.g. a UE 14) and an infrastructure equipment 102 (e.g. an AP such as a gNB/TRP 10) in accordance with at least some such embodiments of the present technique. The communications device 101 is configured to transmit signals to and/or receive signals from the wireless communications network, for example, to and from the infrastructure equipment 102. Specifically, the communications device 101 may be configured to transmit data to and/or receive data from the wireless communications network (e.g. to/from the infrastructure equipment 102) via a wireless radio interface provided by the wireless communications network (e.g. a Uu interface between the communications device 101 and the Radio Access Network (RAN), which includes the infrastructure equipment 102). Here, the communications device 101 and the infrastructure equipment may, together with one or more other communications devices 104 (and optionally with one or more other APs/gNBs which are not shown in the example of FIG. 11), form a subnetwork of the wireless communications network. The communications device 101 and the infrastructure equipment 102 each comprise a transceiver (or transceiver circuitry) 101.1, 102.1, and a controller (or controller circuitry) 101.2, 102.2. Each of the controllers 101.2, 102.2 may be, for example, a microprocessor, a CPU, or a dedicated chipset, etc.

As shown in the example of FIG. 11, the transceiver circuitry 101.1 and the controller circuitry 101.2 of the communications device 101 are configured to determine 121 values of one or more transmission parameters (e.g. based on an uplink/sidelink grant received from the infrastructure equipment 102 or based on the communications device 101 selecting grant-free uplink or sidelink resources) in accordance with which the communications device 101 is to transmit data over a radio channel to the infrastructure equipment 102 or one of the other communications devices 104, to predict 122, based on one or more characteristics of the wireless communications network, one or more properties of the radio channel, to determine 123, based on the predicted properties 122 of the radio channel, updated values of the one or more transmission parameters, and to transmit, over the radio channel either 124a to the infrastructure equipment 102 or to 124b the one of the other communications devices 104, the data in accordance with the updated values 123 of the one or more transmission parameters.

Essentially then, embodiments of the present technique propose that the radio channel between one or more UEs and an AP and/or between two or more UEs (for sidelink communications) are predicted in advance, so that the AP and/or the UE can take preventive scheduling decisions and measures if a potential transmission failure is expected. The channel prediction is based on highly predictable characteristics of either the network in general, or of a subnetwork (formed by one or more UEs and one or more APs). As those skilled in the art would appreciate, the specific arrangements of embodiments of the present disclosure described in the proceeding paragraphs may be applied, where appropriate, to either or both of the example wireless communications systems shown in, and described with respect to, FIGS. 10 and 11, where the predictive scheduling decisions are controlled by the AP and UE respectively.

In some arrangements of embodiments of the present technique, the known characteristics are movements of UEs or other objects, or indeed of the AP itself (e.g. the movements of UEs, APs, or other objects within the subnetwork). In other words, the one or more characteristics of the wireless communications network comprise movement of the communications device and/or movement of one or more of the other communications devices and/or movement of the infrastructure equipment and/or movement of one or more objects within the wireless communications network. Here, such movement may be within a subnetwork as described above, and such movement may be that of the UE/other UEs/objects relative to the AP or other UEs in the network/subnetwork, or may be absolute movement. Such arrangements recognise that, particularly in subnetworks, the movement of the UE relative to the AP (and/or to other UEs) or movements of objects within the subnetwork, is highly predictable or may be known in advance, and the subnetwork can utilise this information to predict the channel between the UE and AP at a given time. The AP can therefore schedule transmission involving the UE using transmission parameters based on the predicted channel instead of on prior channel measurements which may be outdated by the time at which that transmission is actually performed. For example, the transmission parameter can be a more robust MCS if the predicted channel is worse than the prior measured channel, or can in other examples be (or also be) a change in transmission power or transmission direction (e.g. the direction of the beam used for the transmission, or the direction of the transmission itself such that the transmission is transmitted via a relay node or a repeater such as a Reconfigurable Intelligent Surface (RIS)). The transmission parameters may also be the number of repetitions scheduled for a particular transmission.

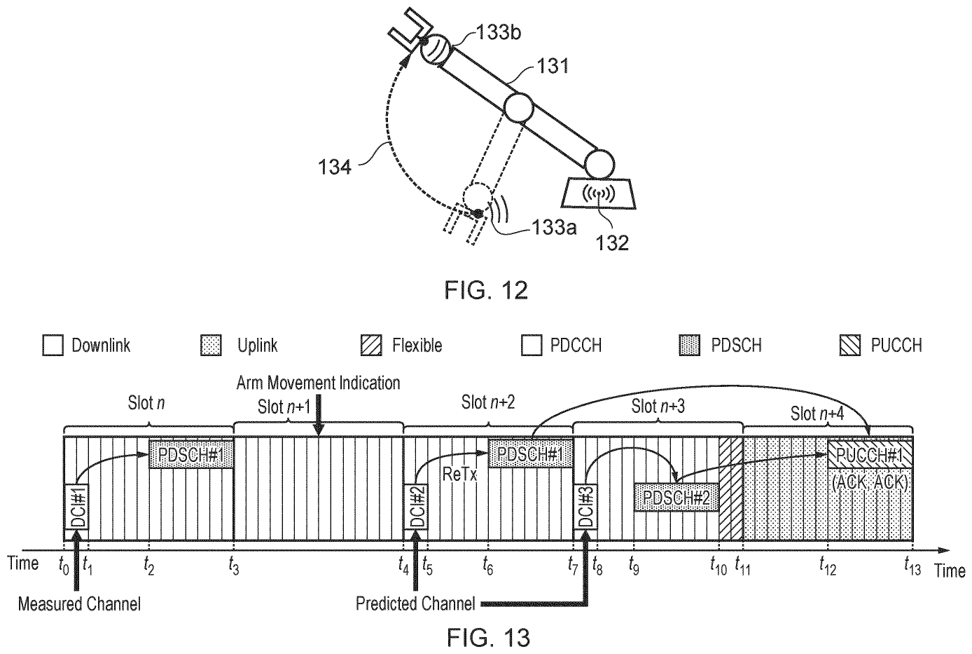

An example is shown in FIG. 12, which illustrates a subnetwork of a robotic arm 131. The subnetwork comprises a UE 133 located on a robotic hand located at the end of the robotic arm 131, and an AP 132 is located at the base of the robotic arm 131. The movements 134 of the robotic arm 131 are highly predictable. For example, when the robotic arm 131 extends 134, the UE 133 will move from a first position 133a to a second position 133b. The radio channel between the UE 133 and the AP 132 when the UE 133 is located at each of the first position 133a and the second position 133b can be measured and therefore known at the AP 132 in advance (where such measurements can be updated if necessary). When the AP 132 has a packet to transmit to the UE 133, and if it receives an indication (or if the AP 132 already knows the trajectory of the arm 131) that the robotic arm 131 is moving or has moved, it can predict the UE's 133 radio channel at the time the AP 132 performs the transmission. Therefore, the AP 132 is able to schedule the transmission of the packet accordingly. For example, the MCS used for the transmission when the UE is located in the first position 133a may be higher than an MCS used were the UE located in the second position 133b (as this is further from the AP 132), or the AP 132 will direct its beam towards the second position 133b rather than the first position 133a since it knows the UE 133 will be located at the second position 133b at that time.

An example of predictive scheduling using information of the robotic arm movement is shown in FIG. 13. In Slot n, the AP sends a DL Grant DCI #1 to the UE to schedule PSDCH #1 in the same slot, where the scheduling is based on measurements taken on the radio channel, such as CQI feedback received prior to Slot n. Prior to Slot n, the UE is in a first position (such as the first position 133a of FIG. 12) where it is located close to the AP and therefore the CQI reports suggest a good radio condition leading to PDSCH #1 being scheduled with a high MCS. In Slot n+1, the AP receives an indication (e.g. from the application layer) indicating that the robotic arm has started moving just before Slot n (here, it should be noted that, to compensate for delay, the Arm Movement Indication would indicate the time at which the arm started moving). The AP therefore realises that the MCS scheduled for PDSCH #1 in DCI #1 is too optimistic and likely to fail based on the predicted channel. Consequently, the AP sends DL Grant DCI #2 to schedule a pre-emptive retransmission of PDSCH #1 (without waiting for HARQ feedback in response to the transmission of PDSCH #1 it performed in Slot n) in Slot n+2 to ensure that the UE can successfully decode PDSCH #1. In Slot n+3, the AP sends DL Grant DCI #3 to schedule PDSCH #2 and here, instead of using measured channels such as CQI feedback in determining the transmission parameters for PDSCH #2, the AP uses the predicted channel based on the movement of the robotic arm at Slot n+3 to determine the transmission parameter(s), such as MCS, for PDSCH #2. In this example, both PDSCH #1 and PDSCH #2 are successfully decoded and the UE feeds back two ACKs in PUCCH #1.

Those skilled in the art would also appreciate that arrangements of embodiments of the present technique such as those described above with respect to the examples of FIGS. 12 and 13 is also applicable in the uplink. That is, the UE can also receive an application layer indicator to indicate that the relative position of the UE and the AP has changed due to movements (where the path of the movements—of the UEs or other objects—are highly predictable or known to the UE). The UE can then take the predicted channel into account when performing/scheduling its transmissions. For example the UE may perform preventive scheduling and transmit its PUSCH at a higher power (or lower MCS) if it knows that the movement would lead to a poorer radio condition and vice versa, or may be instructed to do so by the AP based on such predictions. The UE may also perform pre-emptive retransmission if the movement is known to lead to poor radio condition and is thus likely to cause the UE's initial transmission to fail (assuming the initial transmission has already been sent).

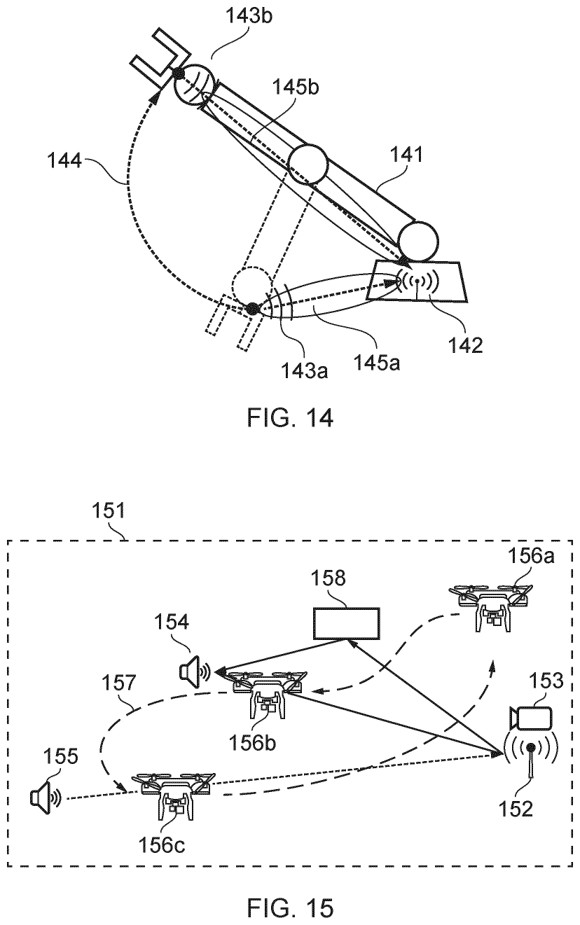

An example is shown in FIG. 14, where the UE 143 at the tip of the robotic arm 141 moves 144 from a first position 143a to a second position 143b due to the movement of the robotic arm 141, thereby changing the relative radio channel between the UE 143 and the AP 142. In this example, the UE 143 may receive application layer information that the robotic arm 141 is moving 144 and consequently, the UE 143 would use an appropriate beam to transmits its uplink transmission to the AP 142. That is, upon determining that the UE's 143 position changes from the first position 143a to the second position 143b, the UE 143 may apply a second beam 145b for its transmission to the AP 142 instead of a first beam 145a as shown in FIG. 14.

It should also be appreciated that arrangements of embodiments of the present technique are not limited to just uplink and downlink transmission, but are also applicable as described above for sidelink transmissions between two or more UEs. That is, the UEs exchanging messages via sidelink can make use of the predictable or known movement of the subnetwork and adjust their transmissions accordingly; either independently, or upon instruction from the AP.

In some arrangements of embodiments of the present technique, as noted above, the known characteristics may be the movements of one or more objects in the network/subnetwork. The movement of the objects are predictable to the APs and may be monitored by the subnetwork, e.g. via a camera. An example is shown in FIG. 15, where a subnetwork 151 (e.g. in a house) consists of AP 152, a first UE 153, a second UE 154, and a third UE 155. A security drone 156 flies around the house in accordance with a known flight path 157. The flight path 157 can be monitored by a camera, e.g. UE 153, which feeds the information to the AP 152. In this example, UE 154 and UE 155 have line of sight (LOS) with the AP 152. However, occasionally, the LOS is blocked by the drone 156, e.g. the second position 156b and the third position 156c of the drone 156 block the LOS for UE 154 and UE 155 respectively. The AP 152 can therefore predict the radio channel (on a basis of the movement of the drone 156) and use a different transmission scheme to reach the UEs 154 and 155. For example, when the drone 156 is in the second position 156b, the AP 152 loses LOS with UE 154 and knowing this, it may use a Reconfigurable Intelligent Surface (RIS) 158 to redirect its DL transmission to UE 154 to overcome the LOS. The UEs 153, 154, 155 may also be informed of the flight path of the drone 156, and if the drone 156 blocks the LOS of one of these UEs 153, 154, 155, such as the drone 156 in the third position 156c blocking LOS of UE 155, the UE 155 may transmit at a higher power (or using a lower MCS) to overcome the drop in radio channel condition so that its uplink transmission reaches and is successfully decoded by the AP 152.

In some arrangements of embodiments of the present technique, as noted above, the known characteristics may be the movements of one or more UEs in the network/subnetwork. That is, the radio channel between a UE and an AP may be predicted based on the movement of one or more other UEs (or the UE involved in the transmission itself) in the subnetwork. The movement of the UE can be signalled in advance to the AP and, here, the movement does not need to follow a known path. The AP can determine which UE causes significant changes to the radio channel of another UE and instruct that UE to report its position or its near future position.

Using the same example in FIG. 15, the drone 156 can be a UE belonging to the subnetwork and here the drone 156 may indicate its position to the AP 152. Alternatively or additionally, the drone 156 may report when it would be at a certain position; for example the drone 156 may signal to the AP 152 that it will be at the second position 156b during the next radio frame, and so the AP 152 would prepare to schedule UE 154 by directing a beam to the RIS 158 instead of directly to the UE 154 during that radio frame.

In some arrangements of embodiments of the present technique, the known characteristics may be the relative distances between UEs or between UEs and the AP within the network/subnetwork, and/or the angles between the UEs/APs (i.e. in respect of the transmission angle between any two UEs or a UE and an AP involved in a transmission such that the beam that would be most appropriate for that transmission may be determined). In other words, the one or more characteristics of the wireless communications network may comprise a distance between the communications device and either the infrastructure equipment or one of one or more other communications devices and/or an angle between the communications device and either the infrastructure equipment or one of one or more other communications devices. The known characteristics may also comprise known previous properties of the radio channel (e.g. a previous channel estimation performed by one of the UEs, for example during movement of that UE).

It would be appreciated by those skilled in the art that, although many of the arrangements of embodiments of the present technique are described herein with respect to subnetworks, such arrangements can also be applied outside of a subnetwork, such as within a cellular network covering a city or particular geographical area or some other subset of devices. For example, a UE may be located inside a car driving in a certain direction, and the AP may predict that the car will be behind a wall/building during a certain period and then re-emerge again from behind that wall/building with LOS. Hence, the AP can apply predictive scheduling employing a different transmission scheme to reach the UE during that certain period.

In some arrangements of embodiments of the present technique, during movement within or of a subnetwork, the UEs whose radio channels are significantly changed may be triggered by the network (e.g. via signalling from the AP) to provide measurement feedback of the channel, such as SNR, CQI, or channel estimation, so that the AP updates its knowledge of the radio channel conditions during such movements and with the UEs and other objects located at specific positions. The AP can record these radio channel conditions and use them to quickly predict the radio channel conditions at future times when there is traffic exchange between the AP and UE (or indeed between two UEs) during such movements within or of the subnetwork. That is, the movements within the subnetwork may act as an event trigger for the UE to perform measurements or to perform more frequent measurements and to report them to the AP. The AP can then decide which movements act as an event trigger for specific UEs, since some movements in a subnetwork affect only specific UEs and not other UEs. In other words, the infrastructure equipment may be configured to receive, from at least one of the communications device and the other communications devices, a first measurement report and a second measurement report each comprising measurements performed by the at least one communications device, wherein the second measurement report is transmitted by the at least one communications device in response to detecting a change in the one or more properties of the radio channel, and wherein the first measurement report is transmitted periodically by the at least one communications device.

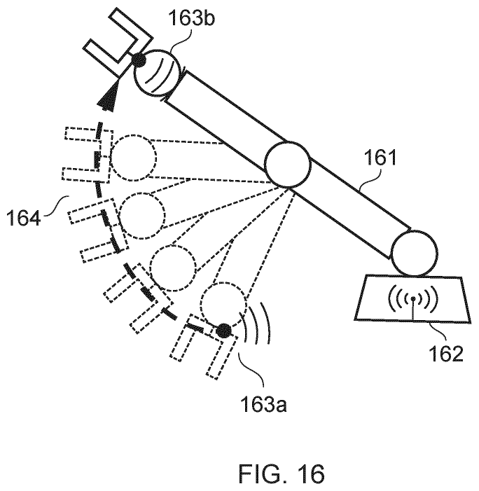

An example is shown in FIG. 16, where a robotic arm 161 is a subnetwork comprising an AP at the base of the robotic arm 161 and a UE 163 at the tip of the robotic arm 161. The movement 164 of the robotic arm 161 causes the UE 163 to move from a first position 163a to a second position 163b. This movement 164 triggers the UE 163 to perform frequent measurements during the move, where the measurement can consist of the UE's 163 positions (e.g. including positions 163a and 163b), and any one or more of the SNR, CQI and channel estimations experienced by the UE 163 at these positions. In the example shown by FIG. 16, the UE 163 may perform five sets of measurements during the move 164, and the UE 163 may report these five sets of measurements when it reaches the second position 163b. Alternatively, the UE 163 may report each set of measurements separately as each set of measurements is completed.

In some arrangements of embodiments of the present technique, the UE may be configured (e.g. by the AP) to provide at least two different measurement reports. Here, a first measurement report may have a longer periodicity (i.e. is transmitted less frequently) than a second measurement report. In other words, the first measurement report may be received from the at least one communications device less frequently than the second measurement report. Alternatively or additionally, the first and second measurement reports may have the same reporting periodicity, but the second measurement report may contain a higher number measurements taken at a faster rate than the first measurement report. In other words, the second measurement report comprises a higher number of measurements than the first measurement report. For example, the first measurement reports may have a periodicity of 2 ms and the first measurement report contains only one single measurement, i.e. measurements are performed at a rate of one every 2 ms, whereas the second measurement report may contain five measurements, i.e. measurements are performed at a rate of one every 0.4 ms. The UE may perform the first measurement reporting when it is not moving and the second measurement reporting when the subnetwork movements cause significant change to the radio channel between the UE and the AP. That is, the movement acts as an event trigger for the UE to switch from a first measurement report to a second measurement report. This recognises that the radio channel does not change much when the UE is stationary and so less frequent measurement of the channel is needed compared to the case when the UE is moving, which causes more rapid change to the radio channel and so more frequent measurements are needed. More measurements of the channel would also enable the AP to more accurately predict the channel during such movements in the future; for example by interpolating between two measured channel estimates, the AP can predict the radio channel of the UE in any position during movement within the subnetwork.

In some arrangements of embodiments of the present technique, the UE indicates its estimated future position to the AP. In other words, the infrastructure equipment may be configured to receive, from at least one of the communications device and the other communications devices, an indication of an estimated future position of the at least one communications device, wherein the one or more characteristics of the wireless communications network comprises the estimated future position of the at least one communications device. That is, the UE indicates its estimated position in the next Tₚₒₛ ms, where Tₚₒₛ is configured by the AP. This is beneficial for the AP in predicting the radio channel between the UE and the AP or between another UE and the AP if the UE causes significant changes to the radio channel between the other UE and the AP. For the example in FIG. 15, the AP 152 may configure the drone UE 156 to indicate its estimated position that is 10 ms away in the future, so that the AP 152 can determine when the drone 156 would block the LOS between UE 154 or UE 155 and the AP 152.

In some arrangements of embodiments of the present technique, the UE indicates when it will be at specific locations in the future. In other words, the infrastructure equipment may be configured to receive, from at least one of the communications device and the other communications devices, an indication of a time at which the at least one communications device will be at each of one or more geographical locations, wherein the one or more characteristics of the wireless communications network comprises the indication of the time at which the at least one communications device will be at each of the one or more geographical locations. The specific locations are configured by the AP and these may correspond to positions that cause or are expected to cause significant changes to the radio channel between the UE and the AP or between another UE and the AP (or indeed between two UEs in the case of sidelink communications). In other words, the infrastructure equipment may be configured to transmit, to the at least one communications device, an indication of the one or more geographical locations. The UE can indicate to the AP when it is T_{target} away from a specific location, where T_{target} can be configured by the AP. For the example in FIG. 15, the AP 152 may configure the drone UE 156 to indicate to the network when it is T_{target}=5 ms away from each of the second position 156b and the third position 156c. By indicating beforehand when the drone 156 will be at each of the second position 156b and the third position 156c, the AP 152 has sufficient time to schedule its transmission to UE 154 and UE 155 using appropriate transmission parameters.

In some arrangements of embodiments of the present technique, the AP indicates to one or more UEs, e.g. using a GC-DCI (group common DCI), when a movement within the subnetwork causes significant changes to the radio conditions of the one or more UEs. In other words, the communications device may be configured to receive, from the infrastructure equipment, an indication that one or more of the properties of the radio channel have changed. The indication can be transmitted to the UE T_{AP-impact} ms prior to the actual movement to give sufficient time for the impacted UEs to adjust their transmissions (if any) to the AP or to other UEs. The value of T_{AP-impact} can be configured by the AP. In other words, the communications device may be configured to receive, from the infrastructure equipment, an indication that one or more of the properties of the radio channel will change at a specified time.

In some arrangements of embodiments of the present technique, one or more UEs can indicate to one or more other UEs, T_{UE-impact} ms prior to a movement in the subnetwork that causes significant changes to the radio conditions among these UEs for sidelink communications. The value of T_{UE-impact} can be configured by the AP. In other words, the communications device may be configured to transmit, to one or more of the other communications devices, an indication that one or more of the properties of the radio channel have changed and/or an indication that one or more of the properties of the radio channel will change at a specified time.

In some arrangements of embodiments of the present technique, the application layer indicates to lower layers (e.g. Layer 2 or Layer 1) of one or more known movements. For example, the application at the robotic arm can indicate to the AP or UE that it is going to extend its arm. In other words, the communications device or the infrastructure equipment may be configured to receive, from a higher layer, an indication of the one or more characteristics of the wireless communications network.

In some arrangements of embodiments of the present technique, the network may enable or disable (or configure) when it is going to apply the predictive scheduling (or pre-emptive retransmission). The network (e.g. AP) may also signal to a UE when that UE is required to apply predictive scheduling that the UE itself has control of, because the predictive scheduling may not applicable to all deployment scenarios. In other words, the communications deice may be configured to receive, from the infrastructure equipment in advance of transmitting the data in accordance with the updated values of the one or more transmission parameters, an indication that the communications device is enabled to transmit the data in accordance with the updated values of the one or more transmission parameters.

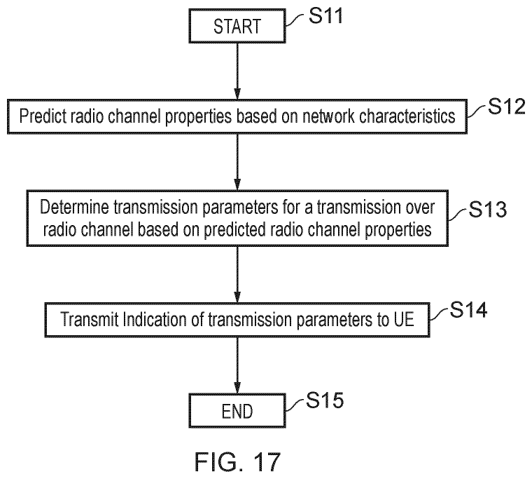

FIG. 17 shows a flow diagram illustrating a first example process of communications in a communications system in accordance with at least some embodiments of the present technique. The process shown by FIG. 17 is specifically a method of operating an infrastructure equipment (i.e. AP such as a gNB) forming part of a wireless communications network configured to transmit signals to and/or to receive signals from a communications device (i.e. UE).

The method begins in step S11. The method comprises, in step S12, predicting, based on one or more characteristics of the wireless communications network, one or more properties of a radio channel between the communications device and either the infrastructure equipment or one of one or more other communications devices. In step S13, the process comprises determining, based on the predicted properties of the radio channel, one or more transmission parameters to be used for a transmission over the radio channel. Then, in step S14, the method comprises transmitting, to the communications device, a control signal comprising an indication of the one or more transmission parameters to be used for the transmission over the radio channel. The process ends in step S15.

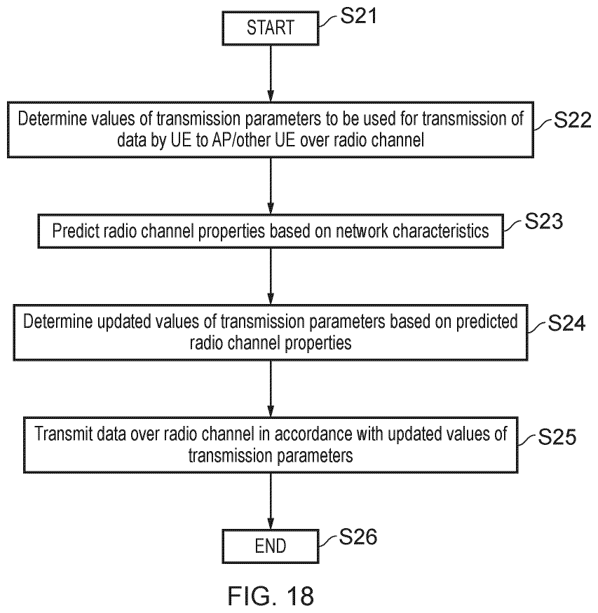

FIG. 18 shows a flow diagram illustrating a second example process of communications in a communications system in accordance with at least some embodiments of the present technique. The process shown by FIG. 18 is specifically a method of operating a communications device (i.e. UE) configured to transmit signals to and/or to receive signals from an infrastructure equipment (i.e. AP such as a gNB) and/or one or more other communications devices (i.e. UEs).

The method begins in step S21. The method comprises, in step S22, determining values of one or more transmission parameters in accordance with which the communications device is to transmit data over a radio channel to the infrastructure equipment or one of the other communications devices. In step S23, the process comprises predicting, based on one or more characteristics of the wireless communications network, one or more properties of the radio channel. Then, in step S24, the method comprises determining, based on the predicted properties of the radio channel, updated values of the one or more transmission parameters. Following this, in step S25, the process comprises transmitting, over the radio channel to the infrastructure equipment or the one of the other communications devices, the data in accordance with the updated values of the one or more transmission parameters. The process ends in step S26.

Those skilled in the art would appreciate that the methods shown by FIGS. 17 and 18 may be adapted in accordance with embodiments of the present technique. For example, other intermediate steps may be included in such methods, or the steps may be performed in any logical order. Though embodiments of the present technique have been described largely by way of the example communications systems shown in FIGS. 10 and 11, and further by way of the implementation examples shown in FIGS. 12 to 16, it would be clear to those skilled in the art that they could be equally applied to other systems to those described herein, provided that these are within the scope of the claims.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure, provided that these are within the scope of the claims.

The following numbered paragraphs provide further example aspects and features of the present technique:

Paragraph 1. A method of operating an infrastructure equipment forming part of a wireless communications network configured to transmit signals to and/or to receive signals from a communications device, the method comprising
predicting, based on one or more characteristics of the wireless communications network, one or more properties of a radio channel between the communications device and either the infrastructure equipment or one of one or more other communications devices,
determining, based on the predicted properties of the radio channel, one or more transmission parameters to be used for a transmission over the radio channel, and
transmitting, to the communications device, a control signal comprising an indication of the one or more transmission parameters to be used for the transmission over the radio channel.

Paragraph 2. A method according to Paragraph 1, wherein the transmission over the radio channel comprises the infrastructure equipment transmitting downlink data to the communications device.

Paragraph 3. A method according to Paragraph 1 or Paragraph 2, wherein the transmission over the radio channel comprises the infrastructure equipment receiving uplink data from the communications device.

Paragraph 4. A method according to any of Paragraphs 1 to 3, wherein the transmission over the radio channel comprises the communications device transmitting sidelink data to one of the other communications devices.

Paragraph 5. A method according to any of Paragraphs 1 to 4, wherein the transmission over the radio channel comprises the communications device receiving sidelink data from one of the other communications devices.

Paragraph 6. A method according to any of Paragraphs 1 to 5, wherein the control signal indicates that the transmission over the radio channel is a retransmission of a previous transmission over the radio channel, and wherein the control signal is transmitted by the infrastructure equipment before an acknowledgement feedback signal is transmitted in response to the previous transmission.

Paragraph 7. A method according to any of Paragraphs 1 to 6, wherein the one more characteristics of the wireless communications network are characteristics of a subnetwork of the wireless communications network, and wherein the communications device, the one or more other communications devices, and the infrastructure equipment together form the subnetwork.

Paragraph 8. A method according to any of Paragraphs 1 to 7, wherein the one or more characteristics of the wireless communications network comprise movement of the communications device.

Paragraph 9. A method according to any of Paragraphs 1 to 8, wherein the one or more characteristics of the wireless communications network comprise movement of the infrastructure equipment.

Paragraph 10. A method according to any of Paragraphs 1 to 9, wherein the one or more characteristics of the wireless communications network comprise movement of one or more of the other communications devices.

Paragraph 11. A method according to any of Paragraphs 1 to 10, wherein the one or more characteristics of the wireless communications network comprise movement of one or more objects within the wireless communications network.

Paragraph 12. A method according to any of Paragraphs 1 to 11, wherein the one or more characteristics of the wireless communications network comprise a distance between the communications device and either the infrastructure equipment or one of one or more other communications devices.

Paragraph 13. A method according to any of Paragraphs 1 to 12, wherein the one or more characteristics of the wireless communications network comprise an angle between the communications device and either the infrastructure equipment or one of one or more other communications devices.

Paragraph 14. A method according to any of Paragraphs 1 to 13, wherein the one or more characteristics of the wireless communications network comprise one or more previous properties of the radio channel.

Paragraph 15. A method according to any of Paragraphs 1 to 14, wherein the one or more transmission parameters to be used for the transmission over the radio channel comprise a transmission power.

Paragraph 16. A method according to any of Paragraphs 1 to 15, wherein the one or more transmission parameters to be used for the transmission over the radio channel comprise a modulation and coding scheme.

Paragraph 17. A method according to any of Paragraphs 1 to 16, wherein the one or more transmission parameters to be used for the transmission over the radio channel comprise a transmission direction.

Paragraph 18. A method according to any of Paragraphs 1 to 17, wherein the one or more transmission parameters to be used for the transmission over the radio channel comprise a number of scheduled repetitions.

Paragraph 19. A method according to any of Paragraphs 1 to 18, comprising receiving, from at least one of the communications device and the other communications devices, a first measurement report and a second measurement report each comprising measurements performed by the at least one communications device, wherein the second measurement report is transmitted by the at least one communications device in response to detecting a change in the one or more properties of the radio channel, and wherein the first measurement report is transmitted periodically by the at least one communications device.

Paragraph 20. A method according to Paragraph 19, wherein the first measurement report is received from the at least one communications device less frequently than the second measurement report.

Paragraph 21. A method according to Paragraph 19 or Paragraph 20, wherein the second measurement report comprises a higher number of measurements than the first measurement report.

Paragraph 22. A method according to any of Paragraphs 1 to 21, comprising
receiving, from at least one of the communications device and the other communications devices, an indication of an estimated future position of the at least one communications device, wherein the one or more characteristics of the wireless communications network comprises the estimated future position of the at least one communications device.

Paragraph 23. A method according to any of Paragraphs 1 to 22, comprising
receiving, from at least one of the communications device and the other communications devices, an indication of a time at which the at least one communications device will be at each of one or more geographical locations, wherein the one or more characteristics of the wireless communications network comprises the indication of the time at which the at least one communications device will be at each of the one or more geographical locations.

Paragraph 24. A method according to Paragraph 23, comprising transmitting, to the at least one communications device, an indication of the one or more geographical locations.

Paragraph 25. A method according to any of Paragraphs 1 to 24, comprising receiving, from a higher layer, an indication of the one or more characteristics of the wireless communications network.

Paragraph 26. An infrastructure equipment forming part of a wireless communications network, the infrastructure equipment comprising
transceiver circuitry configured to transmit signals to and/or to receive signals from a communications device, and
controller circuitry configured in combination with the transceiver circuitry
to predict, based on one or more characteristics of the wireless communications network, one or more properties of a radio channel between the communications device and either the infrastructure equipment or one of one or more other communications devices,
to determine, based on the predicted properties of the radio channel, one or more transmission parameters to be used for a transmission over the radio channel, and
to transmit, to the communications device, a control signal comprising an indication of the one or more transmission parameters to be used for the transmission over the radio channel.

Paragraph 27. Circuitry for an infrastructure equipment forming part of a wireless communications network, the circuitry comprising
transceiver circuitry configured to transmit signals to and/or to receive signals from a communications device, and
controller circuitry configured in combination with the transceiver circuitry
to predict, based on one or more characteristics of the wireless communications network, one or more properties of a radio channel between the communications device and either the infrastructure equipment or one of one or more other communications devices,
to determine, based on the predicted properties of the radio channel, one or more transmission parameters to be used for a transmission over the radio channel, and
to transmit, to the communications device, a control signal comprising an indication of the one or more transmission parameters to be used for the transmission over the radio channel.

Paragraph 28. A method of operating a communications device configured to transmit signals to and/or to receive signals from a wireless communications network and/or one or more other communications devices, the method comprising
receiving, from the infrastructure equipment, a control signal comprising an indication of one or more transmission parameters to be used for the transmission over a radio channel between the communications device and either the infrastructure equipment or one of the other communications devices, wherein the one or more transmission parameters are based on one or more predicted properties of the radio channel which are predicted based on one or more characteristics of the wireless communications network, and
performing the transmission over the radio channel with the infrastructure equipment or the one of the other communications devices.

Paragraph 29. A method according to Paragraph 28, wherein the transmission over the radio channel comprises the communications device receiving downlink data from the infrastructure equipment.

Paragraph 30. A method according to Paragraph 28 or Paragraph 29, wherein the transmission over the radio channel comprises the communications device transmitting uplink data to the infrastructure equipment.

Paragraph 31. A method according to any of Paragraphs 28 to 30, wherein the transmission over the radio channel comprises the communications device transmitting sidelink data to one of the other communications devices.

Paragraph 32. A method according to any of Paragraphs 28 to 31, wherein the transmission over the radio channel comprises the communications device receiving sidelink data from one of the other communications devices.

Paragraph 33. A method according to any of Paragraphs 28 to 32, wherein the control signal indicates that the transmission over the radio channel is a retransmission of a previous transmission over the radio channel, and wherein the control signal is received from the infrastructure equipment before an acknowledgement feedback signal is transmitted in response to the previous transmission.

Paragraph 34. A method according to any of Paragraphs 28 to 33, wherein the one more characteristics of the wireless communications network are characteristics of a subnetwork of the wireless communications network, and wherein the communications device, the one or more other communications devices, and the infrastructure equipment together form the subnetwork.

Paragraph 35. A method according to any of Paragraphs 28 to 34, wherein the one or more characteristics of the wireless communications network comprise movement of the communications device.

Paragraph 36. A method according to any of Paragraphs 28 to 35, wherein the one or more characteristics of the wireless communications network comprise movement of the infrastructure equipment.

Paragraph 37. A method according to any of Paragraphs 28 to 36, wherein the one or more characteristics of the wireless communications network comprise movement of one or more of the other communications devices.

Paragraph 38. A method according to any of Paragraphs 28 to 37, wherein the one or more characteristics of the wireless communications network comprise movement of one or more objects within the wireless communications network.

Paragraph 39. A method according to any of Paragraphs 28 to 38, wherein the one or more characteristics of the wireless communications network comprise a distance between the communications device and either the infrastructure equipment or one of one or more other communications devices.

Paragraph 40. A method according to any of Paragraphs 28 to 39, wherein the one or more characteristics of the wireless communications network comprise an angle between the communications device and either the infrastructure equipment or one of one or more other communications devices.

Paragraph 41. A method according to any of Paragraphs 28 to 40, wherein the one or more characteristics of the wireless communications network comprise one or more previous properties of the radio channel.

Paragraph 42. A method according to any of Paragraphs 28 to 41, wherein the one or more transmission parameters to be used for the transmission over the radio channel comprise a transmission power.

Paragraph 43. A method according to any of Paragraphs 28 to 42, wherein the one or more transmission parameters to be used for the transmission over the radio channel comprise a modulation and coding scheme.

Paragraph 44. A method according to any of Paragraphs 28 to 43, wherein the one or more transmission parameters to be used for the transmission over the radio channel comprise a transmission direction.

Paragraph 45. A method according to any of Paragraphs 28 to 44, wherein the one or more transmission parameters to be used for the transmission over the radio channel comprise a number of scheduled repetitions.

Paragraph 46. A method according to any of Paragraphs 28 to 45, comprising
transmitting, to the infrastructure equipment, a first measurement report and a second measurement report each comprising measurements performed by the communications device, wherein the second measurement report is transmitted in response to the communications device detecting a change in the one or more properties of the radio channel, and wherein the first measurement report is transmitted periodically by the at least one communications device.

Paragraph 47. A method according to Paragraph 46, wherein the first measurement report transmitted to the infrastructure equipment less frequently than the second measurement report.

Paragraph 48. A method according to Paragraph 46 or Paragraph 47, wherein the second measurement report comprises a higher number of measurements than the first measurement report.

Paragraph 49. A method according to any of Paragraphs 28 to 48, comprising
transmitting, to the infrastructure equipment, an indication of an estimated future position of the communications device, wherein the one or more characteristics of the wireless communications network comprises the estimated future position of the communications device.

Paragraph 50. A method according to any of Paragraphs 28 to 49, comprising
transmitting, to the infrastructure equipment, an indication of a time at which the communications device will be at each of one or more geographical locations, wherein the one or more characteristics of the wireless communications network comprises the indication of the time at which the communications device will be at each of the one or more geographical locations.

Paragraph 51. A method according to Paragraph 50, comprising
receiving, from the infrastructure equipment, an indication of the one or more geographical locations.

Paragraph 52. A communications device comprising
transceiver circuitry configured to transmit signals to and/or to receive signals from a wireless communications network and/or one or more other communications devices, and
controller circuitry configured in combination with the transceiver circuitry
to receive, from the infrastructure equipment, a control signal comprising an indication of one or more transmission parameters to be used for the transmission over a radio channel between the communications device and either the infrastructure equipment or one of the other communications devices, wherein the one or more transmission parameters are based on one or more predicted properties of the radio channel which are predicted based on one or more characteristics of the wireless communications network, and
to perform the transmission over the radio channel with the infrastructure equipment or the one of the other communications devices.

Paragraph 53. Circuitry for a communications device, the circuitry comprising
transceiver circuitry configured to transmit signals to and/or to receive signals from a wireless communications network and/or one or more other communications devices, and
controller circuitry configured in combination with the transceiver circuitry
to receive, from the infrastructure equipment, a control signal comprising an indication of one or more transmission parameters to be used for the transmission over a radio channel between the communications device and either the infrastructure equipment or one of the other communications devices, wherein the one or more transmission parameters are based on one or more predicted properties of the radio channel which are predicted based on one or more characteristics of the wireless communications network, and
to perform the transmission over the radio channel with the infrastructure equipment or the one of the other communications devices.

Paragraph 54. A method of operating a communications device configured to transmit signals to and/or to receive signals from a wireless communications network and/or one or more other communications devices, the method comprising
determining values of one or more transmission parameters in accordance with which the communications device is to transmit data over a radio channel to the infrastructure equipment or one of the other communications devices,
predicting, based on one or more characteristics of the wireless communications network, one or more properties of the radio channel,
determining, based on the predicted properties of the radio channel, updated values of the one or more transmission parameters, and
transmitting, over the radio channel to the infrastructure equipment or the one of the other communications devices, the data in accordance with the updated values of the one or more transmission parameters.

Paragraph 55. A method according to Paragraph 54, wherein the one more characteristics of the wireless communications network are characteristics of a subnetwork of the wireless communications network, and wherein the communications device, the one or more other communications devices, and the infrastructure equipment together form the subnetwork.

Paragraph 56. A method according to Paragraph 54 or Paragraph 55, wherein the one or more characteristics of the wireless communications network comprise movement of the communications device.

Paragraph 57. A method according to any of Paragraphs 54 to 56, wherein the one or more characteristics of the wireless communications network comprise movement of the infrastructure equipment.

Paragraph 58. A method according to any of Paragraphs 54 to 57, wherein the one or more characteristics of the wireless communications network comprise movement of one or more of the other communications devices.

Paragraph 59. A method according to any of Paragraphs 54 to 58, wherein the one or more characteristics of the wireless communications network comprise movement of one or more objects within the wireless communications network.

Paragraph 60. A method according to any of Paragraphs 54 to 59, wherein the one or more characteristics of the wireless communications network comprise a distance between the communications device and either the infrastructure equipment or one of one or more other communications devices.

Paragraph 61. A method according to any of Paragraphs 54 to 60, wherein the one or more characteristics of the wireless communications network comprise an angle between the communications device and either the infrastructure equipment or one of one or more other communications devices.

Paragraph 62. A method according to any of Paragraphs 54 to 61, wherein the one or more characteristics of the wireless communications network comprise one or more previous properties of the radio channel.

Paragraph 63. A method according to any of Paragraphs 54 to 62, wherein the one or more transmission parameters to be used for the transmission over the radio channel comprise a transmission power.

Paragraph 64. A method according to any of Paragraphs 54 to 63, wherein the one or more transmission parameters to be used for the transmission over the radio channel comprise a modulation and coding scheme.

Paragraph 65. A method according to any of Paragraphs 54 to 64, wherein the one or more transmission parameters to be used for the transmission over the radio channel comprise a transmission direction.

Paragraph 66. A method according to any of Paragraphs 54 to 65, wherein the one or more transmission parameters to be used for the transmission over the radio channel comprise a number of scheduled repetitions.

Paragraph 67. A method according to any of Paragraphs 54 to 66, comprising
receiving, from the infrastructure equipment, an indication that one or more of the properties of the radio channel have changed.

Paragraph 68. A method according to any of Paragraphs 54 to 67, comprising receiving, from the infrastructure equipment, an indication that one or more of the properties of the radio channel will change at a specified time.

Paragraph 69. A method according to any of Paragraphs 54 to 68, comprising
transmitting, to one or more of the other communications devices, an indication that one or more of the properties of the radio channel have changed.

Paragraph 70. A method according to any of Paragraphs 54 to 69, comprising
transmitting, to one or more of the other communications devices, an indication that one or more of the properties of the radio channel will change at a specified time.

Paragraph 71. A method according to any of Paragraphs 54 to 70, comprising
receiving, from the infrastructure equipment in advance of transmitting the data in accordance with the updated values of the one or more transmission parameters, an indication that the communications device is enabled to transmit the data in accordance with the updated values of the one or more transmission parameters.

Paragraph 72. A method according to any of Paragraphs 54 to 71, comprising
receiving, from a higher layer, an indication of the one or more characteristics of the wireless communications network.

Paragraph 73. A communications device comprising
transceiver circuitry configured to transmit signals to and/or to receive signals from a wireless communications network and/or one or more other communications devices, and
controller circuitry configured in combination with the transceiver circuitry
to determine values of one or more transmission parameters in accordance with which the communications device is to transmit data over a radio channel to the infrastructure equipment or one of the other communications devices,
to predict, based on one or more characteristics of the wireless communications network, one or more properties of the radio channel,
to determine, based on the predicted properties of the radio channel, updated values of the one or more transmission parameters, and
to transmit, over the radio channel to the infrastructure equipment or the one of the other communications devices, the data in accordance with the updated values of the one or more transmission parameters.

Paragraph 74. Circuitry for a communications device, the circuitry comprising
transceiver circuitry configured to transmit signals to and/or to receive signals from a wireless communications network and/or one or more other communications devices, and
controller circuitry configured in combination with the transceiver circuitry
to determine values of one or more transmission parameters in accordance with which the communications device is to transmit data over a radio channel to the infrastructure equipment or one of the other communications devices,
to predict, based on one or more characteristics of the wireless communications network, one or more properties of the radio channel,
to determine, based on the predicted properties of the radio channel, updated values of the one or more transmission parameters, and
to transmit, over the radio channel to the infrastructure equipment or the one of the other communications devices, the data in accordance with the updated values of the one or more transmission parameters.

Paragraph 75. A wireless communications system comprising an infrastructure equipment according to Paragraph 26 and a communications device according to Paragraph 52.

Paragraph 76. A computer program comprising instructions which, when loaded onto a computer, cause the computer to perform a method according to any of Paragraphs 1 to 25, Paragraphs 28 to 51, or Paragraphs 54 to 72.

Paragraph 77. A non-transitory computer-readable storage medium storing a computer program according to Paragraph 76.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] TR 38.913, “Study on Scenarios and Requirements for Next Generation Access Technologies (Release 14)”, third Generation Partnership Project, v14.3.0, August 2017.
[2] RP-190726, “Physical layer enhancements for NR ultra-reliable and low latency communication (URLLC)”, Huawei, HiSilicon, RAN #83, March 2019.
[3] RP-201310, “Revised WID: Enhanced Industrial Internet of Things (IoT) and ultra-reliable and low latency communication (URLLC) support for NR,” Nokia, Nokia Shanghai Bell, RAN #88e, July 2020.
[4] European Patent Application, Publication No. EP4104343.
[5] R1-1808256, “Prediction-Based early feedback,” TCL Communication, RAN1 #93, August 2018.

1. A method of operating an infrastructure equipment forming part of a wireless communications network configured to transmit signals to and/or to receive signals from a communications device, the method comprising
predicting, based on one or more characteristics of the wireless communications network, one or more properties of a radio channel between the communications device and either the infrastructure equipment or one of one or more other communications devices,
determining, based on the predicted properties of the radio channel, one or more transmission parameters to be used for a transmission over the radio channel, and
transmitting, to the communications device, a control signal comprising an indication of the one or more transmission parameters to be used for the transmission over the radio channel.

2. A method according to claim 1, wherein the transmission over the radio channel comprises the infrastructure equipment transmitting downlink data to the communications device.

3. A method according to claim 1, wherein the transmission over the radio channel comprises the infrastructure equipment receiving uplink data from the communications device.

4. A method according to claim 1, wherein the transmission over the radio channel comprises the communications device transmitting sidelink data to one of the other communications devices.

5. A method according to claim 1, wherein the transmission over the radio channel comprises the communications device receiving sidelink data from one of the other communications devices.

6. A method according to claim 1, wherein the control signal indicates that the transmission over the radio channel is a retransmission of a previous transmission over the radio channel, and wherein the control signal is transmitted by the infrastructure equipment before an acknowledgement feedback signal is transmitted in response to the previous transmission.

7. A method according to claim 1, wherein the one more characteristics of the wireless communications network are characteristics of a subnetwork of the wireless communications network, and wherein the communications device, the one or more other communications devices, and the infrastructure equipment together form the subnetwork.

8. A method according to claim 1, wherein the one or more characteristics of the wireless communications network comprise movement of the communications device.

9. A method according to claim 1, wherein the one or more characteristics of the wireless communications network comprise movement of the infrastructure equipment.

10. A method according to claim 1, wherein the one or more characteristics of the wireless communications network comprise movement of one or more of the other communications devices.

11. A method according to claim 1, wherein the one or more characteristics of the wireless communications network comprise movement of one or more objects within the wireless communications network.

12. A method according to claim 1, wherein the one or more characteristics of the wireless communications network comprise a distance between the communications device and either the infrastructure equipment or one of one or more other communications devices.

13. A method according to claim 1, wherein the one or more characteristics of the wireless communications network comprise an angle between the communications device and either the infrastructure equipment or one of one or more other communications devices.

14. A method according to claim 1, wherein the one or more characteristics of the wireless communications network comprise one or more previous properties of the radio channel.

15. A method according to claim 1, wherein the one or more transmission parameters to be used for the transmission over the radio channel comprise a transmission power.

16. A method according to claim 1, wherein the one or more transmission parameters to be used for the transmission over the radio channel comprise a modulation and coding scheme.

17. A method according to claim 1, wherein the one or more transmission parameters to be used for the transmission over the radio channel comprise a transmission direction.

18. A method according to claim 1, wherein the one or more transmission parameters to be used for the transmission over the radio channel comprise a number of scheduled repetitions.

19.-25. (canceled)

26. An infrastructure equipment forming part of a wireless communications network, the infrastructure equipment comprising
transceiver circuitry configured to transmit signals to and/or to receive signals from a communications device, and
controller circuitry configured in combination with the transceiver circuitry
to predict, based on one or more characteristics of the wireless communications network, one or more properties of a radio channel between the communications device and either the infrastructure equipment or one of one or more other communications devices,
to determine, based on the predicted properties of the radio channel, one or more transmission parameters to be used for a transmission over the radio channel, and
to transmit, to the communications device, a control signal comprising an indication of the one or more transmission parameters to be used for the transmission over the radio channel.

27.-51. (canceled)

52. A communications device comprising
transceiver circuitry configured to transmit signals to and/or to receive signals from a wireless communications network and/or one or more other communications devices, and
controller circuitry configured in combination with the transceiver circuitry
to receive, from the infrastructure equipment, a control signal comprising an indication of one or more transmission parameters to be used for the transmission over a radio channel between the communications device and either the infrastructure equipment or one of the other communications devices, wherein the one or more transmission parameters are based on one or more predicted properties of the radio channel which are predicted based on one or more characteristics of the wireless communications network, and
to perform the transmission over the radio channel with the infrastructure equipment or the one of the other communications devices.

53.-77. (canceled)
